(19) United States
(12) Patent Application Publication
(10) Pub. No.: US 2014/0197118 A1
(43) Pub. Date: Jul. 17, 2014

(54) MOUNTING APPARATUS FOR STORAGE DEVICES

(71) Applicants: Hon Hai Precision Industry Co., Ltd., New Taipei (TW); Hong Fu Jin Precision Industry (WuHan) Co., Ltd., Wuhan (CN)

(72) Inventors: YUN-LUNG CHEN, New Taipei (TW); CHUNG CHAI, New Taipei (TW); ZHI-QIANG LI, Wuhan (CN); LEI ZHOU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/949,194

(22) Filed: Jul. 23, 2013

(30) Foreign Application Priority Data
Jan. 17, 2013 (CN) 2013100170686

(51) Int. Cl. G06F 1/18

(52) U.S. Cl. CPC G06F 1/187
USPC 211/26

(57) ABSTRACT

A mounting apparatus includes a chassis, a tray, and a supporting member. The chassis includes a bottom plate and a mounting bracket located on the bottom plate. The tray is used to receive a storage device and rotatably attached to the chassis. The supporting member includes a securing piece, an elastic piece connected to the securing piece, and a supporting portion extending from the elastic piece. The securing piece is secured to the tray, and when the tray is rotated from a first position to a second position, the supporting portion supports the bracket.

### BACKGROUND

1. Technical Field

The present disclosure relates to mounting apparatuses, and particularly to a mounting apparatus for securing storage devices an electronic device.

2. Description of Related Art

Many personal computers include data storage devices such as hard disk drives (HDDs), floppy disk drives, and compact disc-read only memory (CD-ROM) drives. In related art, the data storage devices are attached to a chassis of a computer enclosure using screws. When the storage device needs to be maintained or changed, other electronic components near the storage device may prevent the screwdriver from being used. It is inconvenient to maintain or change the storage devices. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, cutaway view of a mounting apparatus and two storage devices in accordance with an embodiment.

FIG. 2 is similar to FIG. 1, but viewed from a different aspect.

FIG. 3 is an enlarged view of a circled portion III of the mounting apparatus of FIG. 1.

FIG. 4 is an isometric view of a supporting member of the mounting apparatus of FIG. 1.

FIG. 5 is similar to FIG. 1, but the supporting member is secured to a tray of the mounting apparatus.

FIG. 6 is an assembled view of the mounting apparatus of FIG. 1, and the tray is located in a first position.

FIG. 7 is similar to FIG. 6, but viewed from a different aspect.

FIG. 8 is similar to FIG. 6, and the tray is located in a second position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

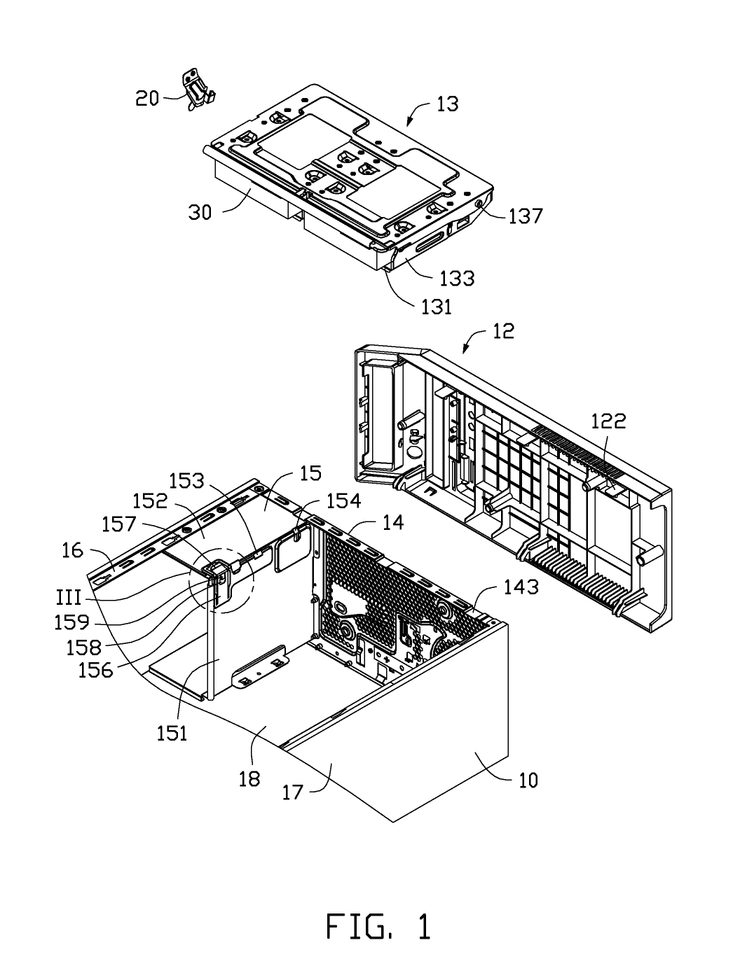

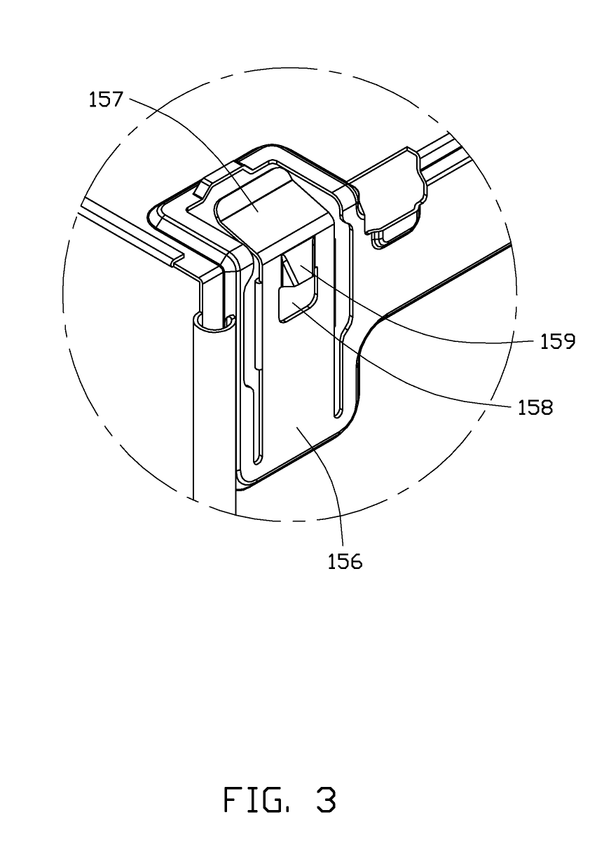

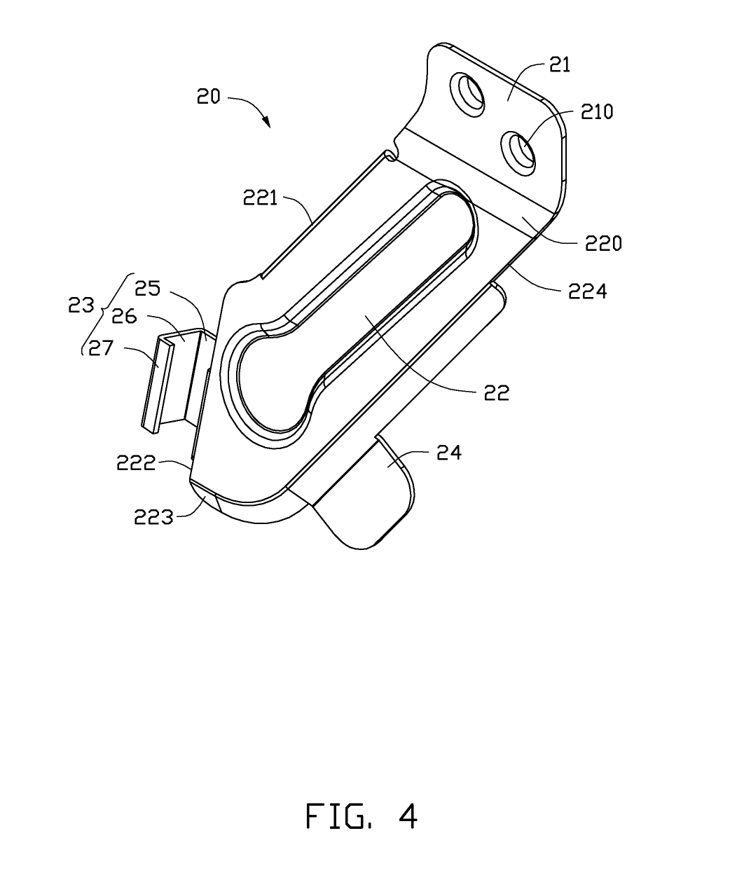

FIGS. 1-4 illustrate a mounting apparatus in accordance with an embodiment. The mounting apparatus comprises a chassis 10, a supporting member 20, and a tray 13. Two storage devices 30 are received in the tray 13. In one embodiment, the two storage devices 30 are hard disk drives (HDDs), floppy disk drives, and compact disc-read only memory (CD-ROM) drives.

The chassis 10 comprises a bottom plate 18, a front plate 14, a first side plate 16, a second side plate 17, and a decorating plate 12. In one embodiment, the first side plate 16 is substantially parallel to the second side plate 17 and perpendicular to the bottom plate 18 and the front plate 14.

A mounting bracket 15 is located between the first side plate 16 and the front plate 14. The mounting bracket 15 comprises a side panel 151 and a top panel 152 substantially perpendicular to the side panel 151. In one embodiment, the side panel 151 is substantially perpendicular to the bottom plate 18 and parallel to the first side plate 16. A receiving hole 153 and a first pivoting hole 154 are defined in the first side panel 151. In one embodiment, the receiving hole 153 and the first pivoting hole 154 is located in a connecting portion which is connected to the side panel 151 and the top panel 152. A resilient portion 156 extends from the side panel 151 and comprises a pressing portion 157 and a clipping portion 158 extending from the pressing portion 157. A clipping hole 159 is defined in the clipping portion 158.

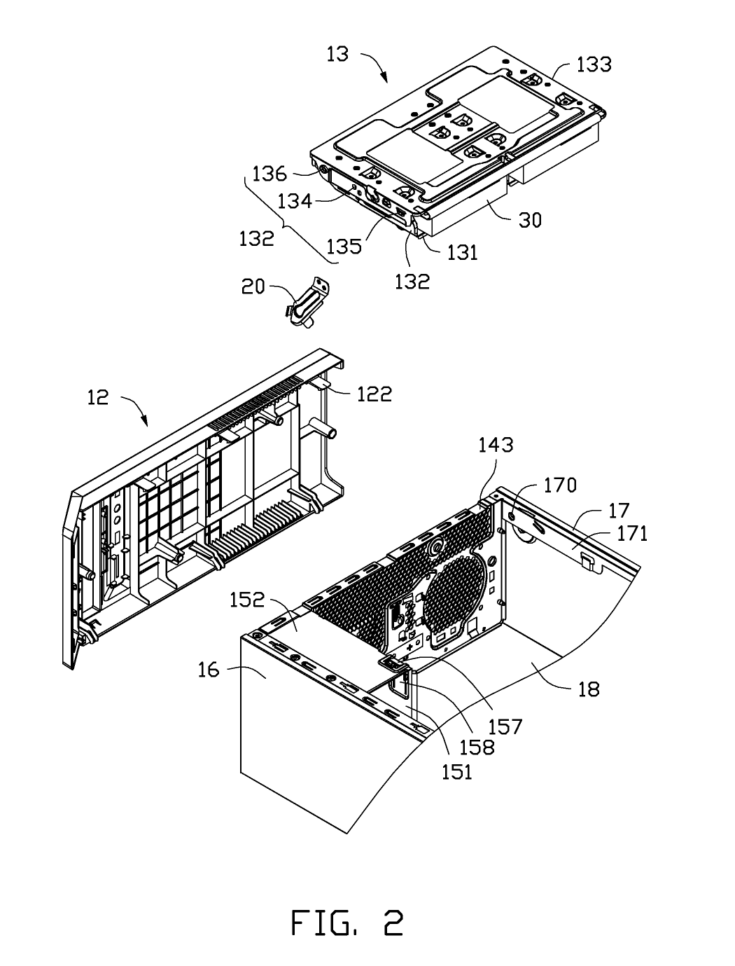

A plurality of hooks 122 is located on the decorating plate 12. A plurality of concave slots 143, corresponding to the plurality of hooks 122, is defined in the front plate 14. A retaining panel 171 (see FIG. 2) extends from a top edge of the second side plate 17. In one embodiment, the retaining panel 171 is substantially parallel to the second side plate 17. A second pivoting hole 170 is defined in the retaining panel 171.

The supporting member 20 comprises a securing piece 21 and an elastic piece 22 extending from the securing piece 21. In one embodiment, the elastic piece 22 is slanted relative to the securing piece 21. Two securing holes 210 are defined in the securing piece 21. The elastic piece 22 comprises a first edge 220, a second edge 221, a third edge 222, a fourth edge 223, and a fifth edge 224. The first edge 220 is connected to the securing piece 21 and substantially parallel to the fourth edge 223. The second edge 221 is substantially parallel to the fifth edge 224 and perpendicular to the first edge 220. The third edge 222 is slanted relative to the fourth edge 223. A positioning portion 23 extends from the third edge 222 and comprises a supporting portion 25, a clasping portion 27, and a connecting portion 26 connected to the supporting portion 25 and the clasping portion 27. The supporting portion 25 is connected to the third edge 222 and substantially parallel to the clasping portion 27. The connecting portion 26 is substantially perpendicular to the supporting portion 25 and the clasping portion 27. An operating piece 24 extends from the fifth edge 224.

The tray 13 comprises a base 131, a first sidewall 132, and a second sidewall 133. The first sidewall 132 is substantially parallel to the second sidewall 133 and perpendicular to the base 131. The first sidewall 132 defines two mounting holes 134. A protrusion 135 and a first shaft 136 are located on the first sidewall 132. In one embodiment, the two mounting holes 134 are located between the protrusion 135 and the first shaft 136. Two fixing members (not shown) are received in the two mounting holes 134 and the two securing holes 210, to secure the supporting member 20 to the first sidewall 132. A second shaft 137 is located on the second sidewall 133.

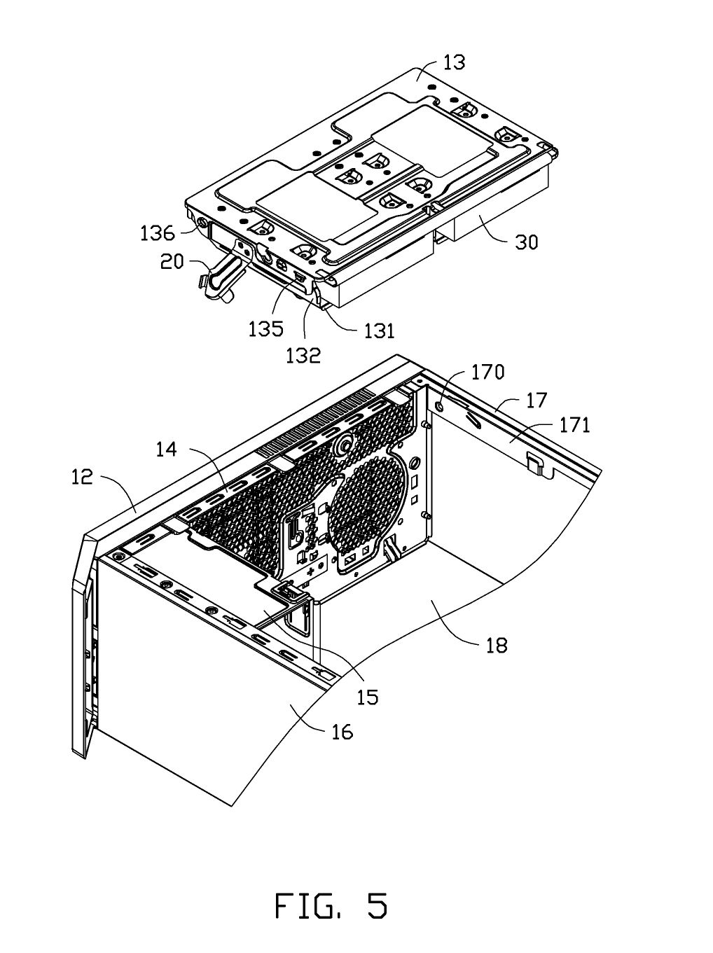

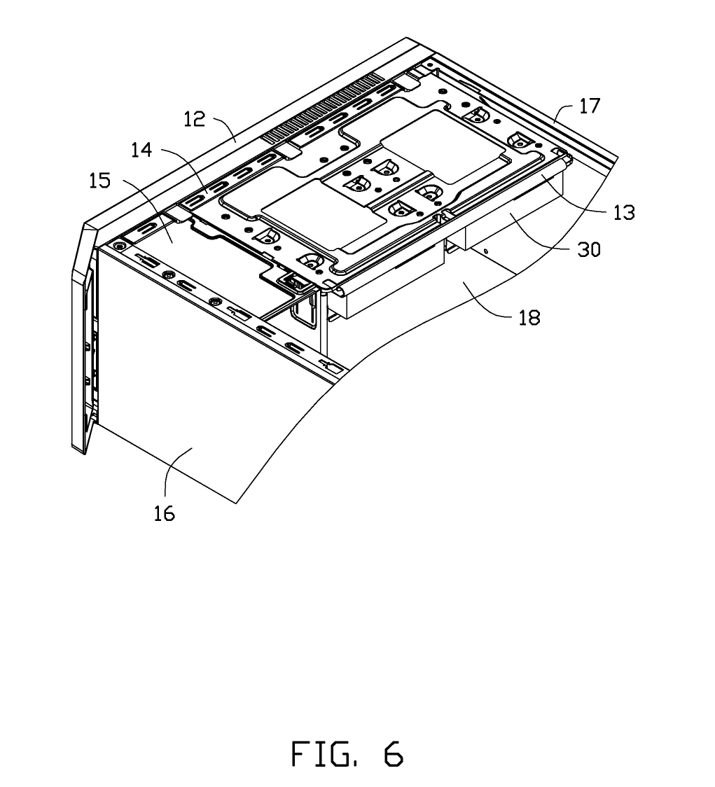

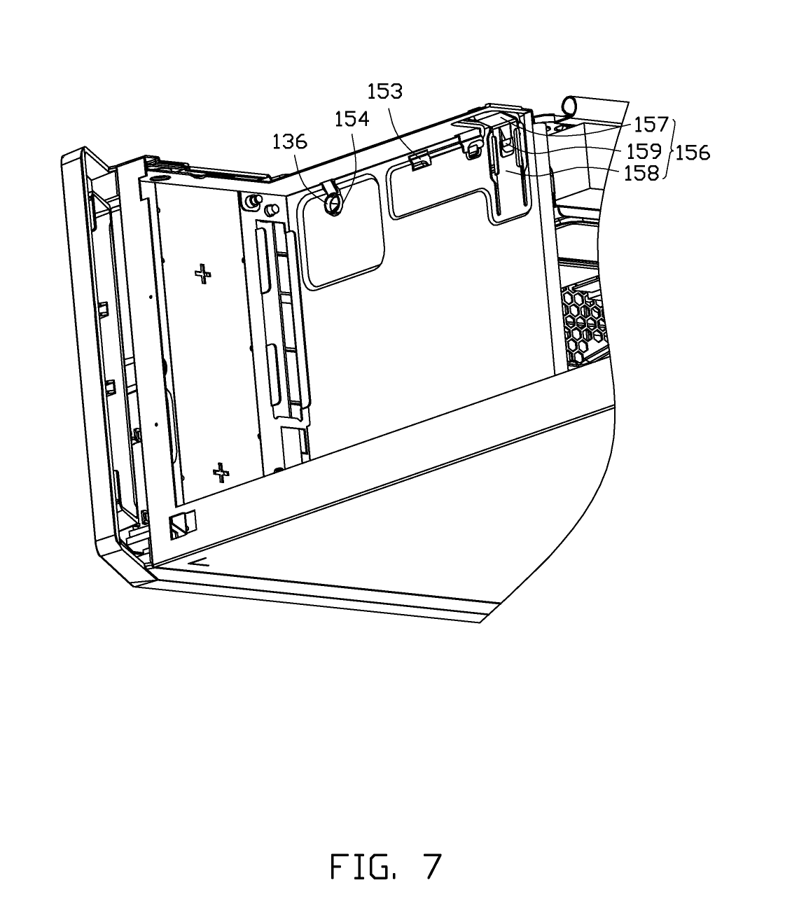

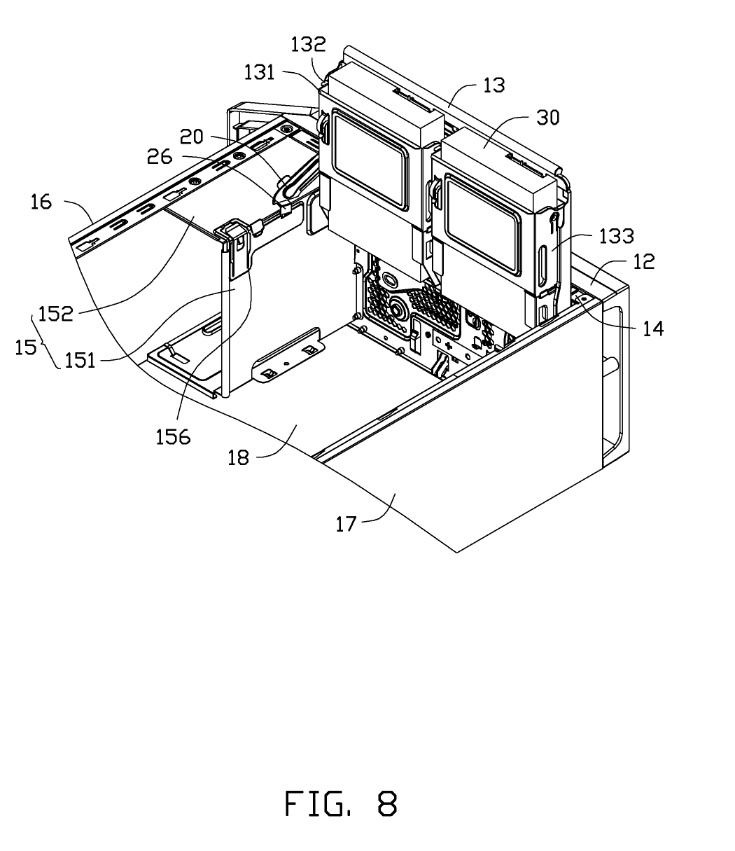

FIGS. 5-8 illustrate that in assembly, the decorating panel 12 is moved towards the front plate 14. The hooks 122 are engaged in the concave slots 143, to engage the decorating panel 12 to the front plate 14. The tray 13 is placed in the chassis 10. The first shaft 136 is engaged in the first pivoting hole 154, and the second shaft 137 is engaged in the second pivoting hole 170, to rotatably secure the tray 13 to the side panel 151 and the retaining panel 171. The first shaft 136 and the second shaft 137 cooperatively define an axis that is substantially perpendicular to the side panel 151. The tray 13 is rotated about the axis and toward the bottom plate 18, until the protrusion 135 is clipped into the clipping hole 159. At this time, the tray 13 is located in a first position, the base 131 is substantially parallel to the bottom plate 18, and the supporting plate 20 abuts the side panel 151.

In disassembly of the storage devices 30, the pressing portion 157 is pressed to deform the resilient portion 156. The protrusion 135 is removed from the clipping hole 159. The tray 13 is rotated about the axis away from the bottom plate 18, until the clasping portion 27 is clipped into the receiving hole 153. Thus, the tray 13 is located in a second position, the supporting portion 25 abuts on the top panel 152, and the base 31 is substantially perpendicular to the bottom plate 11. In the second position, the storage devices 30 can be easily removed from the tray 13.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus comprising:
a chassis comprises a bottom plate and a mounting bracket located on the bottom plate; and the mounting bracket defining a clipping hole;
a tray configured to receive a storage device; and the tray rotatably attached to the chassis, and
a supporting member comprising a securing piece, an elastic piece connected to the securing piece, and a positioning portion extending from the elastic piece; the positioning portion comprising a supporting portion;
wherein the securing piece is secured to the tray; the tray is rotatable relative to the chassis between a first position, where the tray is engaged in the clipping hole; and a second position, where the tray is disengaged from the clipping hole, the supporting member is clipped with the mounting bracket, and the supporting portion is supported on the bracket. >

2. The mounting apparatus of claim 1, wherein the positioning portion further comprises a clasping portion and a connecting portion connected to the clasping portion and the supporting portion, a receiving hole is defined in the bracket, and the clasping portion is received in the receiving hole when the tray is located in the second position.

3. The mounting apparatus of claim 2, wherein the connecting portion is substantially perpendicular to the clasping portion and the supporting portion.

4. The mounting apparatus of claim 3, wherein the clasping portion is substantially parallel to the supporting portion.

5. The mounting apparatus of claim 1, wherein the elastic piece comprises a first edge, a second edge, a third edge, and a fourth edge; the first edge is connected to the securing piece; the second edge is substantially perpendicular to the first edge; the third edge is located between the second edge and the fourth edge and slanted relative to the fourth edge; and the fourth edge is substantially parallel to the first edge; and the supporting portion extends from the third edge.

6. The mounting apparatus of claim 1, wherein the tray comprises a first sidewall, the bracket comprises a side panel and a resilient portion located on the side panel, the resilient portion comprises a clipping portion, and the clipping portion is clipped to the first sidewall when the tray is located in the first position.

7. The mounting apparatus of claim 6, wherein the first sidewall comprises a first shaft, the tray further comprises a second shaft, the second shaft and the first shaft cooperatively defines an axis that is perpendicular to the side panel, and the tray is rotatable about the axis.

8. The mounting apparatus of claim 6, wherein the clipping hole is defined in the clipping portion, the first sidewall comprises a protrusion, and the protrusion is engaged in the clipping hole when the tray is located in the first position.

9. The mounting apparatus of claim 8, wherein the resilient portion further comprises a pressing portion extending from the clipping portion, and the pressing portion is configured to disengage the protrusion from the clipping hole.

10. The mounting apparatus of claim 1, wherein the tray comprises a base, when the tray is located in the first position, the base is substantially parallel to the bottom plate; and when the tray is located in the second position, the base is substantially perpendicular to the bottom plate.

11. A mounting apparatus comprising:
a chassis comprises a bottom plate and a mounting bracket located on the bottom plate; the bottom plate comprises a side plate; the mounting bracket comprising a side panel substantially parallel to the side plate; and the mounting bracket defining a clipping hole
a tray configured to receive a storage device; and the tray located between the side panel and the side plate; and
a supporting member comprising a securing piece secured to the tray, an elastic piece connected to the securing piece, and a positioning portion extending from the elastic piece; and the positioning portion comprising a supporting portion;;
wherein the tray is rotatable about an axis that is substantially perpendicular to the side panel relative to the chassis between a first position, where the tray is engaged in the clipping hole; and a second position, where the tray is disengaged from the clipping hole, and the supporting member is clipped with the mounting bracket, and the supporting portion is supported on the mounting bracket.

12. The mounting apparatus of claim 1, wherein the positioning portion further comprises a clasping portion and a connecting portion connected to the clasping portion and the supporting portion, a receiving hole is defined in the bracket, and the clasping portion is received in the receiving hole when the tray is located in the second position.

13. The mounting apparatus of claim 12, wherein the connecting portion is substantially perpendicular to the clasping portion and the supporting portion.

14. The mounting apparatus of claim 13, wherein the clasping portion is substantially parallel to the supporting portion.

15. The mounting apparatus of claim 11, wherein the elastic piece comprises a first edge, a second edge, a third edge, and a fourth edge; the first edge is connected to the securing piece; the second edge substantially perpendicular to the first edge, the third edge is located between the second edge and the fourth edge and slanted relative to the fourth edge; and the fourth edge is substantially parallel to the first edge; and the supporting portion extends from the third edge.

16. The mounting apparatus of claim 11, wherein the tray comprises a first sidewall, the bracket further comprises a resilient portion located on the side panel, the resilient portion comprises a clipping portion, and the clipping portion is clipped to the first sidewall when the tray is located in the first position.

17. The mounting apparatus of claim 16, wherein the first sidewall comprises a first shaft engaged with the side panel, the chassis further comprises a retaining panel substantially parallel extending from the side plate, the tray further comprises a second shaft engaged with the retaining panel, and the second shaft and the first shaft cooperatively defines the axis.

18. The mounting apparatus of claim 16, wherein the clipping hole is defined in the clipping portion, the first sidewall comprises a protrusion, and the protrusion is engaged in the clipping hole when the tray is located in the first position.

19. The mounting apparatus of claim 18, wherein the resilient portion further comprises a pressing portion extending from the clipping portion, and the pressing portion is configure to disengage the protrusion from the clipping hole.

20. The mounting apparatus of claim 11, wherein the tray comprises a base, when the tray is located in the first position, the base is substantially parallel to the bottom plate; and when the tray is located in the second position, the base is substantially perpendicular to the bottom plate.
